(19) United States
(12) Patent Application Publication
(10) Pub. No.: US 2017/0144484 A1
(43) Pub. Date: May 25, 2017

(54) TRANSPORT TIRE AND METHOD

(71) Applicant: Caterpillar Inc., Peoria, IL (US)

(72) Inventors: David J. Colantoni, Metamora, IL (US); Kevin L. Martin, Washburn, IL (US)

(73) Assignee: Caterpillar Inc., Peoria, IL (US)

(21) Appl. No.: 14/945,562

(22) Filed: Nov. 19, 2015

(51) Int. Cl. B60C 7/28; B60C 7/08; B60C 7/06

(52) U.S. Cl. CPC B60C 7/28; B60C 7/06; B60C 7/08; B60C 2007/005

(57) ABSTRACT

A transport tire is provided for supporting a rim of a machine during transport or storage of the machine. In one form, the transport tire includes a plurality of blocks having a non-annular, handling configuration and an annular, installed configuration. The transport tire includes end portions configured to be releasably connected to secure the blocks in the annular, installed configuration. A method of assembling a transport tire on a rim of a machine is also provided.

### TECHNICAL FIELD

The present disclosure relates to transporting wheeled machines and, more particularly, to transport tires for wheeled machines.

### BACKGROUND

Wheeled machines, such as earth-moving machines, may need to be transported from one location to another for a variety of reasons. For example, the machines may be transported to a delivery destination after manufacture or repair. One approach for transporting such machines involves loading the machines into shipping containers, transporting the shipping containers by boat, truck, and/or train, and unloading the machines from the containers at the delivery destination.

The size of the machine may limit the transportation systems that can be used to reach the delivery destination. In particular, the size of the pneumatic work tires of large machines, such as motor graders and backhoe loaders, may increase the height and/or width of these machines to a size that cannot be accommodated in a shipping container. Reducing the height and/or width of these large machines for transport may be achieved by removing the large work tires from the machines prior to transport.

For example, U.S. Pat. No. 4,570,517 discloses the operations of replacing operating wheels on front and rear axles of a tractor with smaller auxiliary wheels. The auxiliary wheels reduce the height and front end width of the tractor which makes it possible to position more tractors within a shipping container. However, this approach involves removing and handling of the operating wheels and may be somewhat machine specific. Further, the auxiliary wheels may be difficult to install because the installation involves mounting the rear auxiliary wheels to the rear axle and securing the front auxiliary wheels to the front end of the tractor.

### SUMMARY

In one aspect, the present disclosure is directed to a transport tire. The transport tire includes a plurality of blocks having a non-annular, handling configuration and an annular, installed configuration. The transport tire has end portions configured to be connected to secure the blocks in the annular, installed configuration. The transport tire also includes at least one connecting member connecting the blocks and permitting the connected blocks to be repositioned from the annular, installed configuration to the non-annular, handling configuration.

In another aspect, a method is provided for assembling a transport tire on a rim of a machine. The method includes selecting a plurality of blocks that corresponds to a size of a rim. The method further includes positioning the blocks in an annular configuration directly on the rim and securing the blocks in the annular configuration of the rim.

Other features and aspects of this disclosure will be apparent from the following description and the accompanying drawings.

### BRIEF DESCRIPTION OF THE DRAWINGS

FIG. 1 is a side elevational view of a machine with transport tires secured to rims of the machine;

FIG. 2 is a perspective view of one of the transport tires of FIG. 1 secured on one of the rims;

FIG. 3 is a perspective view of the transport tire of FIG. 2 removed from the rim;

FIG. 4 is a side elevational view of a block of the transport tire of FIG. 2;

FIG. 5 is an end elevational view of the block of FIG. 4;

FIG. 6 is an elevational view of a rim that may be used with the transport tire of FIG. 2;

FIG. 7 is a cross-sectional view of the rim of FIG. 6 taken across line 7-7;

FIG. 8 is a perspective view of another transport tire secured to a rim;

FIG. 9 is a perspective view of a block of the transport tire of FIG. 8; and

FIG. 10 is a flow chart illustrating a method of assembling a transport tire on a rim of a machine.

### DETAILED DESCRIPTION

In one aspect, the present disclosure provides an apparatus, such as a transport tire, for supporting a rim of a machine that reduces a height and/or a width of the machine so that conventional shipping containers can more easily or efficiently accommodate the machine for transport. Examples of such machines include those used for construction, mining, farming, or similar industries. The machines may be self-propelled vehicles or vehicles intended to be pushed or pulled by another machine. In some embodiments, the machine may be, for example, a motor grader, tractor, dozer, road reclaimer, scraper, or loader.

The transport tire includes a plurality of track members, such as blocks, having a non-annular, handling configuration and an annular, installed configuration. Prior to transport of the machine, end portions of the transport tire may be releasably connected to secure the blocks in the annular, installed configuration around the rim of the machine. Similarly or differently sized transport tires are secured in a similar manner to the other rims of the machine. The blocks are configured to support the weight of the machine and permit the machine to be driven or towed with the machine rolling on the transport tires secured to the rims. Further, the transport tires distribute the weight of the machine on the rims and protect the rims from objects, such as rocks, when the machine is driven or towed.

In one form, the transport tire includes a plurality of releasable connections that permit one or more of the blocks to be disconnected from the other blocks for a smaller diameter rim or connected to the other blocks for a larger diameter rim. This allows a user or an automated process to adjust a length of the transport tire and tailor a length of the transport tire to correspond to a particular rim. Thus, one transport tire can be easily adjusted for use with a range of different rim sizes by connecting or disconnecting blocks via the releasable connections. For example, a single transport tire can be secured to rims having diameters in the range of approximately 24 inches to approximately 35 inches by adding or removing blocks as appropriate.

In one approach, the transport tires may be secured to rims of a first machine as the machine travels along an assembly line used to manufacture the first machine. The first machine may be driven or towed into storage or a shipping container with the first machine rolling on the transport tires rather than the work tires of the machine. The container may then be transported, such as by boat, truck, and/or train, to the desired destination. Once the first machine has been transported to the desired destination, the first machine may be driven or towed out of the container on the transport tires. The transport tires may then be removed from the rims and the work tires of the first machine are installed on the rims. The transport tires may be reused by shipping the transport tires back to the machine manufacturer. For example, the releasable connections may be released to separate the blocks and break the transport tire down into smaller components that can be stacked or otherwise arranged before being shipped back to the manufacturer in a relatively small container. The manufacturer can then secure the transport tires to rims of a second machine on an assembly line used to manufacture the second machine. The second machine may have rims with larger or smaller diameters than the rims of the first machine. The manufacturer may add blocks to the transport tires to increase the length of the transport tires for larger diameter rims or remove blocks to reduce the length of the transport tire for smaller diameter rims. The manufacturer may also easily replace any blocks that have been damaged, such as during use or transport.

In some approaches, the work tires for the rims are shipped in the container with the machine. In other approaches, the work tires may be shipped directly from the work tire manufacturer and arrive at the transport destination independently from the machine. In some instances, there may be cost savings associated with shipping the work tires directly to the transport destination from the work tire manufacturer. The work tires may then be mounted onto the rims of the machine at the destination. The transport tires may then be shipped back to the place of manufacture of the machine so that the transport tire may be used to transport another machine.

An apparatus is also provided for being releasably secured around a rim of a machine to reduce a height of the machine during transport. The apparatus includes a plurality of track members for being secured around a rim and removed from a rim. The apparatus further includes a plurality of releasable connections connecting the track members together. The releasable connections are configured to permit at least one track member to be disconnected from the other track members for a smaller diameter rim and configured to permit at least one track member to be connected to the other track members for a larger diameter rim.

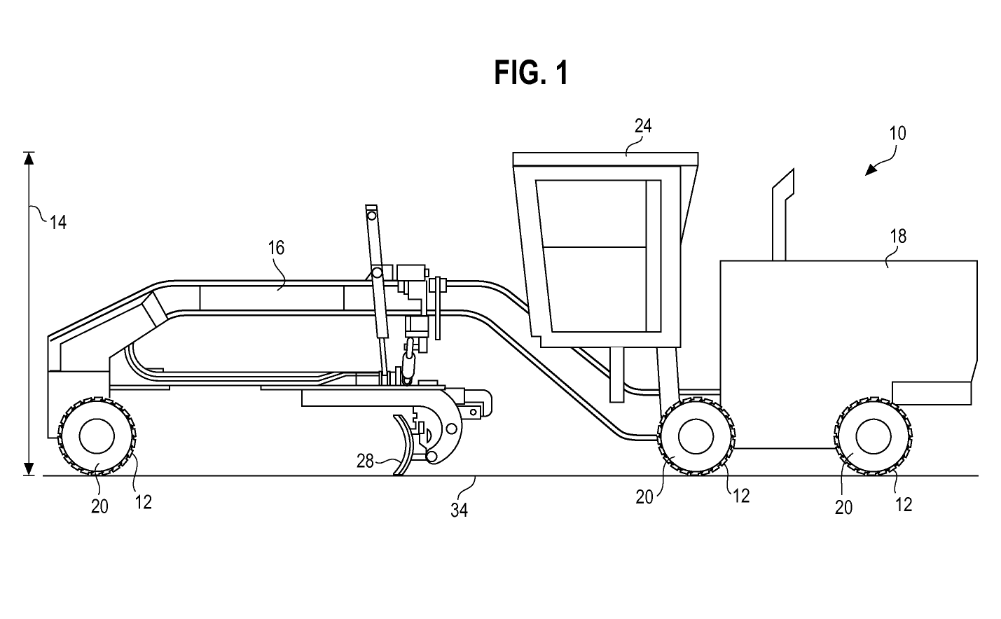

Turning to the figures, FIG. 1 shows a machine such as a motor grader 10 having transport tires 12 secured to rims 20 thereof. The transport tires 12 have a smaller thickness or section height than the work tires intended for use with the rims 20 of the motor grader 10. The transport tires 12 provide a reduced height 14 of the motor grader 10 and permit the motor grader 10 to be driven along a surface 34 and into a transport container on the transport tires 12. With reference to FIG. 4, the transport tire 12 includes blocks 44 each having a section height 32 in the range of approximately three inches to approximately five inches, such as approximately three inches to approximately four inches. By contrast, work tires for motor graders 10 typically have a section height of approximately fourteen inches. The transport tires 12 are also narrower on the rims 20 than the work tires such that, in some applications, the transport tires 12 may provide a reduced width of the motor grader 10.

The motor grader 10 has a chassis 16 with a power train 18 that is operably coupled to rims 20. The chassis 16 of the motor grader 10 also supports an operator station 24 and a blade 28. The transport tires 12 are shown secured to the rims 20 and may be positioned on the rims 20 by the manufacturer of the motor grader 10 such as during assembly of the motor grader 10.

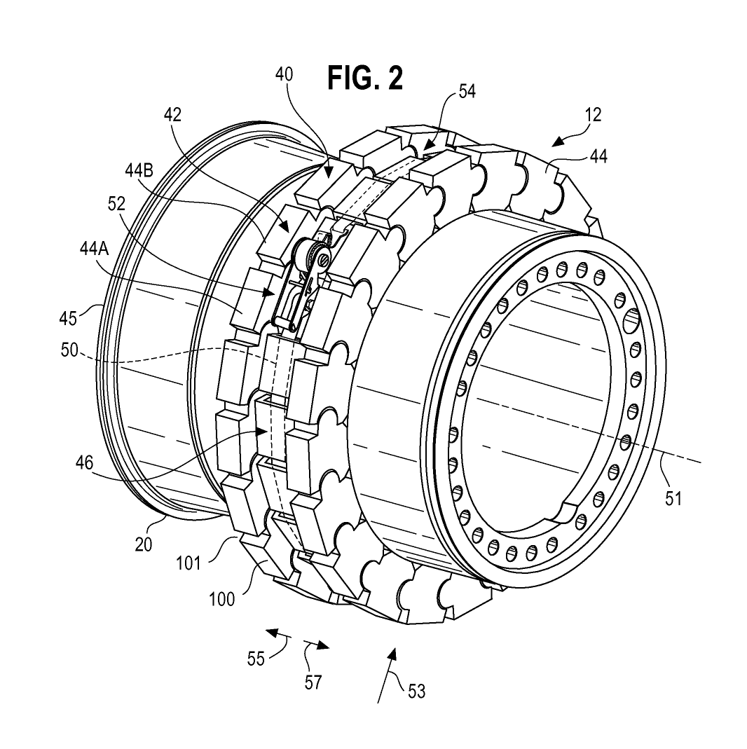

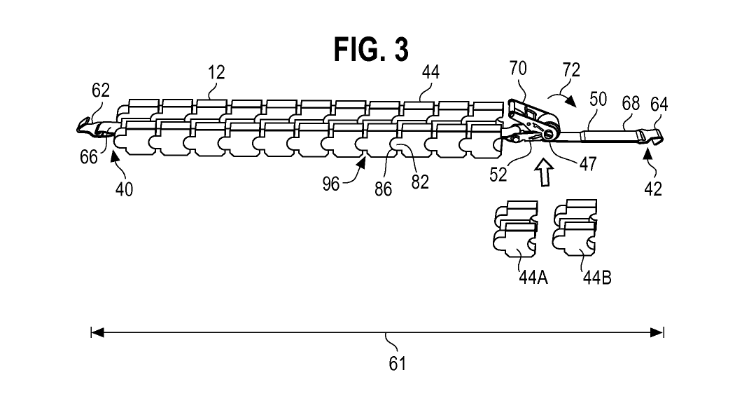

With reference to FIGS. 2 and 3, the transport tire 12 has a pair of end portions 40, 42 that can be joined together to secure the transport tire 12 in an annular configuration around the rim 20. The term rim is used herein to refer to the portion of a wheel which couples a work tire of the wheel to the axle or other drive source. Thus, the rim 20 may encompass a one-piece, integrally formed member as well as multiple components.

The transport tire 12 includes track members, such as blocks 44, which are positioned directly against the rim 20 and support the weight of the motor grader 10 during storage or transport without deformation of the rim 20. The blocks 44 may be rigid, which is intended to mean that the blocks 44 retain their shape during normal operation of the transport tire 12. Although the blocks 44 retain their shape, the blocks 44 in some applications may partially compress due to the weight of the machine supported by the tires. For example, the section height 32 of the blocks 44 may decrease during operation of the transport tire 12 by an amount in the range of approximately five percent to approximately fifteen percent, in another aspect approximately eight percent to approximately thirteen percent. As one example, the section height 32 of the blocks 44 is approximately three inches and the blocks 44 compress one quarter of an inch or less as the motor grader 10 rolls on the transport tires 12. As another example, the section height 32 of the blocks 44 is approximately four inches and the blocks 44 compress one half of an inch or less as the motor grader 10 rolls on the transport tires 12.

The blocks 44 are sized and configured to keep a flange 45 of the rim 20 from contacting the ground when the rim 20 is driven about a rotation axis 51 on the transport tire 12. For example, the flange 45 (see FIG. 2) may extend radially in a range of approximately 1.5 inches to approximately 3 inches. The section height 32 of the blocks 44 (see FIG. 4) is selected to be greater than the height of the flange 45, even when the blocks 44 compress slightly under the weight of the motor grader 10. This ensures that the transport tire 12 keeps the flange 45 of the rim 20 from contacting the ground as the motor grader 10 rolls on the transport tire 12.

The transport tire 12 also includes at least one connecting member, such as a strap 50, extending around the rim 20 and holding the blocks 44 against the rim 20. The strap 50 may be an elongated, flexible member sized to extend around the circumference of the rim 20 and generally conform to the curvature of the rim 20. The strap 50 forms releasable connections 46 with the blocks 44 that permits at least one block 44 to be disconnected from the other blocks 44 to reduce a length 61 (see FIG. 3) of the transport tire 12 and permits at least one block 44 to be connected to the other blocks 44 to increase the length 61 of the transport tire 12.

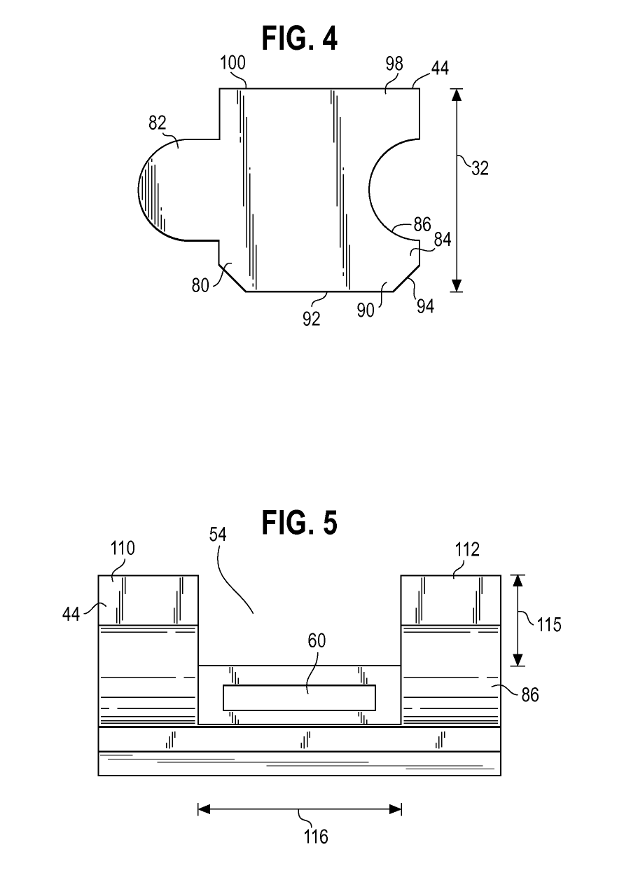

With reference to FIG. 5, each of the blocks 44 has an opening 60 sized to receive the strap 50, with the strap 50 extending through the opening 60 to connect the block 44 to the strap 50. Returning to FIG. 2, the strap 50 connects the blocks 44 together and permits the blocks 44 to be added or removed from the strap 50 to adjust the number of blocks 44. By connecting additional blocks 44, the transport tire 12 can be adjusted to encircle a larger rim 20. By removing blocks 44, the transport tire 12 can be adjusted to encircle a smaller rim 20. In one form, the blocks 44 are identical which makes adding or removing blocks 44 intuitive and efficient because the blocks 44 do not need to be connected to the strap 50 in a particular order.

The transport tire 12 may include a tensioner 52 that is received in an opening, such as a recess 54, of one or more of the blocks 44. The tensioner 52 may be used to apply tension to the strap 50 and create a radially inwardly directed force in direction 53 that presses the blocks 44 tightly against the rim 20, as shown in FIG. 2. Because the strap 50 urges the blocks 44 radially inward against the rim 20, the frictional engagement of the blocks 44 and the rim 20 resists lateral movement in directions 55, 57, as well as circumferential movement around the rim 20. As shown in FIG. 3, the tensioner 52 includes a ratchet 47 having an engaged configuration that resists release of tension in the strap 50 and a release configuration that permits release of tension in the strap 50. The operation of the tensioner 52 can be that of a conventional ratchet-type strap tensioner or it may be a custom configuration.

With reference to FIG. 3, the transport tire 12 has a non-annular, handling configuration which may be generally straight. The strap 50 includes connectors, such as hooks 62, 64, secured to segments 66, 68 of the strap 50. The segments 66, 68 may be lengthened to permit more blocks 44 to be connected to the strap 50 and increase the length 61 of the transport tire 12 and the segments 66, 68 may be shortened as the blocks 44 are removed from the strap 50 to decrease the length 61 of the transport tire 12.

As shown in FIG. 3, the transport tire 12 may have a plurality of blocks 44 connected to the strap 50 prior to positioning the transport tire 12 on the rim 20. To assemble the transport tire 12 on the rim 20, the blocks 44 are assembled on the strap 50 as shown in FIG. 3 by inserting the strap 50 through openings 60 of the blocks 44. The assembled blocks 44 and strap 50 are wrapped around the rim 20. The hooks 62, 64 are connected together to loosely hold the strap 50 and connected blocks 44 in an annular configuration around the rim 20. One or more blocks 44A, 44B (see FIG. 3) that are not connected to the strap 50 are then positioned under the tensioner 52 and nested together with the adjacent blocks 44. The blocks 44A, 44B are used to support the underside of the tensioner 52. As shown in FIG. 2, the strap 50 does not extend through the openings 60 of the blocks 44A, 44B. Next, a lever 70 of the tensioner 52 is pivoted in direction 72 which draws the connected hooks 62, 64 closer to the tensioner 52. This applies tension to the strap 50 and causes the strap 50 to tightly press the blocks 44 against the rim 20. In this manner, the on-board tensioner 52 permits the transport tire 12 to be quickly assembled onto the rim 20 and tensioned to secure the blocks 44, 44A, 44B in the annular configuration thereof around the rim 20. In one approach, the assembled blocks 44 are arranged in a series around the circumference of the rim 20.

With reference to FIGS. 3 and 4, the blocks 44 may have interlocking or nesting portions that allow the blocks 44 to support each other and behave as a single assembly rather than being independently movable on the rim 20. For example, each block 44 may have a male end portion 80 with a projection 82 shaped to mate with a female end portion 84 of an adjacent block 44 having a recess 86. The projection 82 and recess 86 may have matching curvatures to permit controlled pivoting between the blocks 44 as the blocks 44 are being reconfigured from the non-annular, handling configuration to the annular, installed configuration. By controlling relative movement between the blocks 44, the blocks 44 may be easier to handle and reconfigure into the annular configuration. Further, permitting pivoting between the blocks 44 allows the blocks 44 to be pivoted away from one another when the transport tire 12 is being applied to a larger rim 20 and, conversely, the blocks 44 to pivot toward each other when the transport tire 12 is being applied to a smaller rim 20, thereby more closely matching the curvature of a variety of differently sized rims 20.

With reference to FIG. 4, the blocks 44 may each have an inner portion 90 for abutting the rim 20 with a rim surface 92 configured to resist slipping of the block 44 around the rim 20. The rim surface 92 has a substantially planar surface that contacts the rim 20 tangentially. The number of blocks 44 and the relatively short length of the blocks 44 provides a number of contact points around the circumference of the rim 20 and provides even load transfer from the rim 20 to the blocks 44. In some applications, the rim surface 92 may have a coating and/or one or more textures, projections, and embedded materials to resist slipping of the block 44 around the rim 20. In one form, the blocks 44 may deform slightly to conform to the specific curvature of the rim 20. As another example, the rim surface 92 of the blocks 44 may have a concave curvature with a radius of curvature that cooperates with the curvature of the rim 20.

The inner portion 90 of the block 44 may also include sloped surfaces 94 which create gaps 96 between the inner portions 90 of adjacent blocks 44 (see FIG. 3). The gaps 96 provide clearance for the blocks 44 to pivot away and toward one another depending on the size of the rim 20.

Opposite the inner portion 90, the block 44 has an outer portion 98 with a tread surface 100. The tread surface 100 may include a coating and/or one or more textures, projections, coatings, and embedded materials to improve traction on a surface such as terrain or an interior floor of a shipping container or building. The tread surface 100 may be flat or convex, for example. Once the transport tire 12 has been secured in the annular configuration around the rim 20, the tread surfaces 100 may be separated by gaps 101 (see FIG. 2) and form a segmented, annular surface for rolling along a surface with rotation of the rim 20.

With reference to FIG. 5, one or more of the blocks 44 include a pair of wall portions 110, 112 on opposite sides of the recess 54. The recess 54 has a depth 115 and a width 116 sized to permit the tensioner 52 to be received in the recess 54 of the blocks 44A, 44B without the tensioner 52 extending radially outward beyond the wall portions 110, 112. This allows the wall portions 110, 112 to support the weight of the motor grader 10 or other machine without the tensioner 52 being damaged. If most or all of the blocks 44 include the recess 54, the installer may easily position the tensioner 52 in a location along the blocks 44 that is most readily accessible.

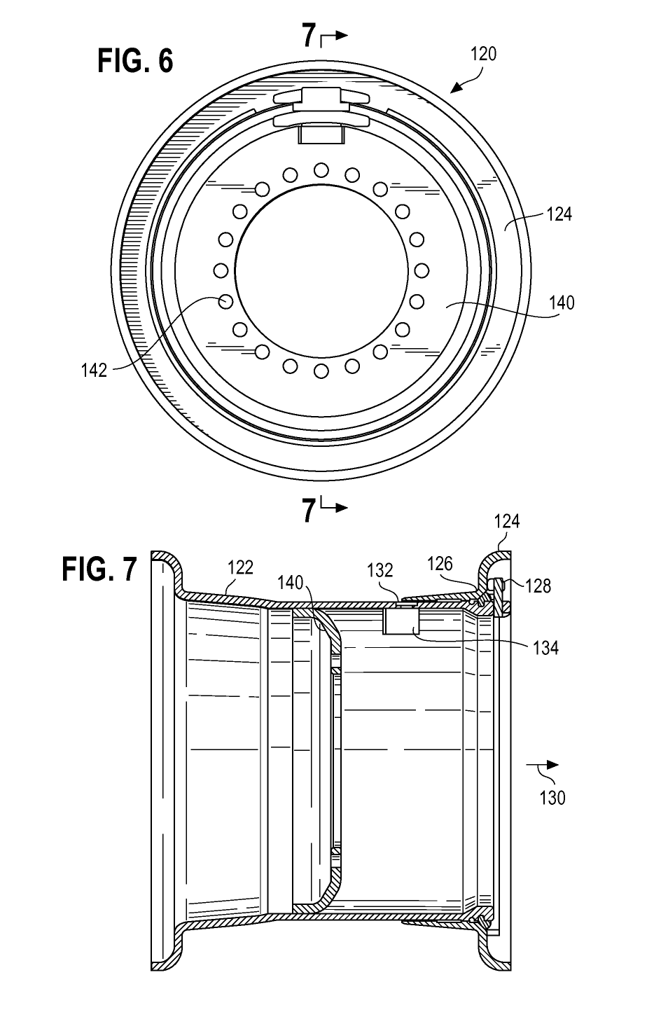

Turning to FIGS. 6 and 7, the transport tire 12 may be used with a variety of rims, such as a multi-piece rim 120. The rim 120 has a rim base 122, a removable flange 124, and a lock ring 126. The rim 120 further includes a key 128 that may be removed to disassemble the rim base 122, flange 124, and lock ring 126. Generally speaking, the lock ring 126 resists movement of the flange 124 in direction 130 once a work tire has been mounted onto the rim base 122 and flange 124. The key 128 maintains the rim base 122, flange 124, and lock ring 126 in the assembled configuration. The rim base 122 has an opening 132 through which a valve stem of the work tire may pass or may be advanced and a valve stem guide 134 which can guide the valve stem along an interior of the rim base 122. The rim base 122 further includes a hub portion 140 with openings 142 for coupling the hub portion 140 to a machine.

The rim 20 may be made of a metallic material, such as steel, and the transport tire 12 is made of materials suited for supporting the motor grader 10 or other machine. The blocks 44 may be made of a metallic material, natural rubber material, synthetic rubber material, other polymer (e.g., urethane), or combination thereof. For example, the blocks 44 may be made of a cast material, such as urethane. As another example, the blocks 44 may be made of recycled materials. The blocks 44 may also include two or more layers of materials. The layers may include a first layer, such as a polymer or a steel, for supporting the weight of the motor grader 10 and a second layer, such as rubber, for providing traction for the transport tire 12. The layers may be made of different materials and each layer may include more than one material within the layer, such as a mix of different types of polymers, rubbers, or other materials.

In some approaches, the strap 50 may be made of nylon (i.e., polyamide), polypropylene, polyester, or a combination thereof. As further examples, the strap 50 may be made of aramid fiber having a high tensile strength, such as poly-para-phenylene terephthalamide sold under the tradename Kevlar®. In another approach, the strap 50 may be made of woven steel.

In some forms, the transport tire 12 may utilize a chain or wire rope in addition to or instead of the strap 50. For example, the transport tire 12 may have a wire rope and a wire rope tensioner. The wire rope tensioner includes male and female members joined to ends of the wire rope. The male and female members have mating threads that permit the male member and/or female member to be turned to engage or disengage the male and female members and draw the ends of the wire rope together, which tensions the wire rope. The wire rope tensioner would also include a lock nut to resist disengagement of the male and female members.

As another example, the transport tire 12 may include the strap 50 but not the tensioner 52. Instead, tension is applied to the strap 50 using a tensioner external to the transport tire 12. In one approach, the strap 50 has a first end connected to a lock and a second, free end that can be fed through the lock in a manner similar to feeding a belt through a belt buckle. The free end of the strap 50 is connected to a tensioner and the tensioner is positioned against the lock. The tensioner then advances the free end of the belt away from the lock which tensions the strap 50 around the rim 20. Next, the lock is reconfigured to a locked position which fixes a portion of the strap 50 within the lock and holds tension in the strap 50. The free end of the strap 50 is disconnected from the tensioner and the tensioner is removed from the strap 50 while the lock maintains tension in the strap 50. Once the motor grader 10 has been transported to its desired destination, the lock is reconfigured to an unlocked position which releases tension in the strap 50 and permits the strap 50 and connected blocks 44 to be removed from the rim 20.

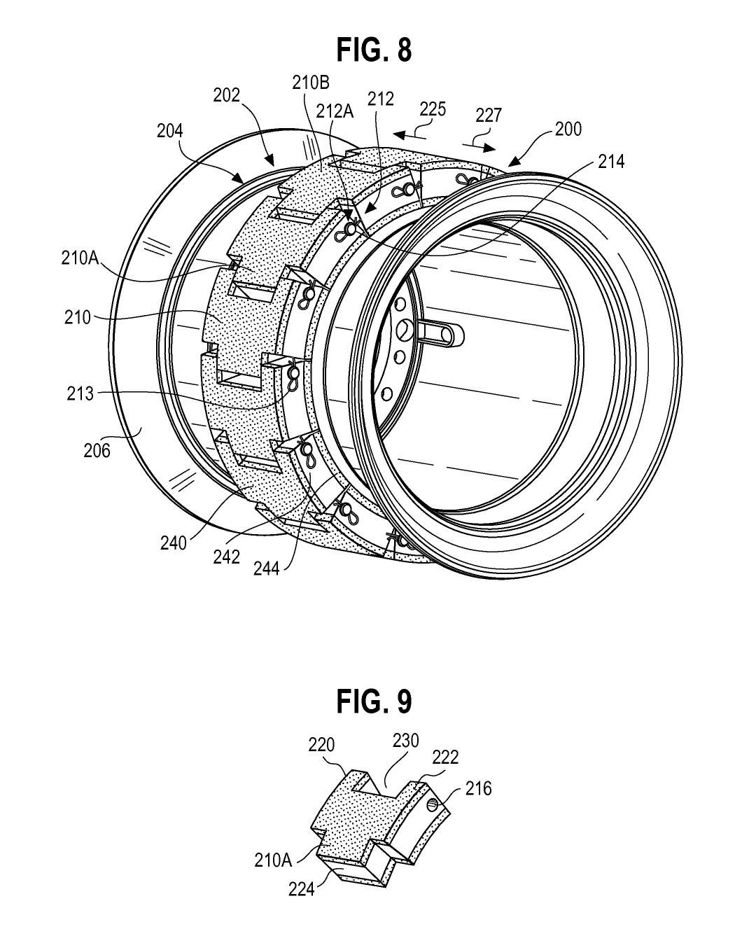

With reference to FIGS. 8 and 9, another transport tire 200 is provided that is similar in many respects to the transport tire 12 discussed above. The transport tire 200 includes end portions 202, 204 that may be releasably joined to secure the transport tire 200 in an annular configuration around a rim 206. The transport tire 200 includes a plurality of blocks 210 and releasable connections 212, such as hinge connections 212A, between the blocks 210. The hinge connections 212A include removable hinge members, such as removable hinge pins 214, which permit the blocks 210 to pivot relative to each other.

Each block 210 has a projection 224 and pair of spaced wall portions 220, 222 that defines a recess 230. The projection 224 of one block 210 extends into the recess 230 of an adjacent block 210 and forms an interlocking or nesting configuration around the rim 206. The nesting configuration of the blocks 210 resists movement of individual blocks in directions 225, 227. Each hinge pin 214 extends through an opening 216 extending through the wall portions 220, 222 of one block 210 and the projection 224 of an adjacent block 210. To tension the transport tire 200, the transport tire 200 may include a master link with an on-board tensioning device, e.g., a worm screw and a worm gear that are operable to draw together hinge pins 214 that connect the master link to adjacent blocks 210.

The hinge pins 214 may include opposite first and second ends, with the first end being enlarged so that the first end cannot fit through the opening 216. The second end of the hinge pin 214 may be sized to fit through the opening 216 but also includes a hole that receives a lock pin or fastener, such as cotter pin 213, to maintain the hinge pin 214 within the opening 216. The cotter pin 213 may be removed from the hole of the second end of the hinge pin 214 and then the second end of the hinge pin 214 may be withdrawn from the opening 216. By removing the hinge pin 214 from the opening 216, the projection 224 of one block 210 can be disconnected from the wall portions 220, 222 of the adjacent block 210. To disconnect the end portions 202, 204, the hinge pin 214 between the blocks 210A, 210B of the end portions 202, 204 is withdrawn. Further, the hinge pins 214 may be removed to decrease the number of blocks 210 or used to add additional blocks 210 to the transport tire 200.

In one form, the blocks 210 may be made of a material including metal, natural rubber, synthetic rubber, other polymer (e.g., urethane), or combination thereof. In one particular form, the blocks 210 include laminated layers including an outer layer 240, an intermediate layer 242, and an inner layer 244. The intermediate layer 242 is sandwiched between the outer and inner layers 240, 244. The layers 240, 242, 244 may be formed of different materials which may be selected to provide desired performance characteristics. For example, the outer and inner layers 240, 244 may include a rubber and/or other polymer. The component of the inner layer 244 is configured to provide friction and compression against the rim 206 and the material of the outer layer 240 is selected to provide traction as the machine upon which the blocks 210 are installed rolls along a surface with rotation of the rim 206. The intermediate layer 242 may be made of a rigid material, such as urethane or steel, and may be cast or otherwise combined with the outer and inner layers 240, 244. Further, one or more of the layers 240, 242, 244 may each include more than one material, such as a combination of polymers, rubbers, recycled materials (e.g., recycled rubber), or other materials. The layers 240, 242, 244 may be secured together using adhesive or in situ molding, for example. In one form, the blocks 210 may be lightweight and the material of the layers 240, 242, 244 are selected to minimize the weight of the blocks 210.

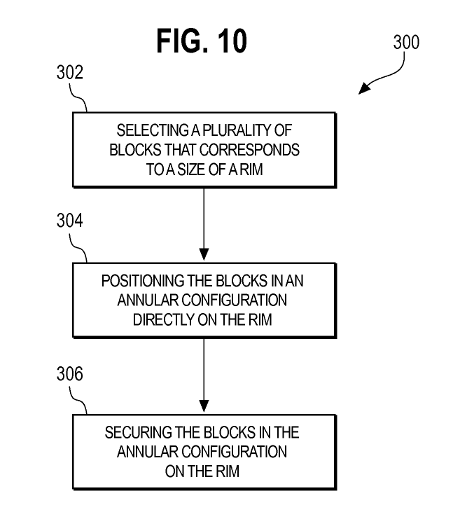

With reference to FIG. 10, a method 300 is provided for assembling a transport tire on a rim of a machine. Referring to the transport tire 12 and rim 20 discussed above, the method 300 includes selecting 302 a plurality of blocks 44 that corresponds to a size of the rim 20. The selecting 302 may be performed by measuring a size of the rim 20, such as diameter or circumference, and determining the appropriate number of blocks 44 that can be used with the rim 20. As another example, the selecting 302 may include referring to a table or other listing of correspondence between size, e.g., diameter or circumference, of the rim 20 and identifying the corresponding number of blocks 44 for the rim 20. The lookup procedure may also be performed by comparing indicia on the rim 20 with a table or other listing that identifies the required number of blocks 44 to support a rim having that indicia. This may also be computerized and be part of an automated process.

The method 300 further includes positioning 304 the blocks 44 in an annular configuration directly on the rim 20. The positioning 304 may include rearranging the blocks 44 from a non-annular, handling configuration to the annular configuration.

The positioning 304 may include lifting the motor grader 10 off of the ground to provide clearance to position the blocks 44 onto the rim 20. If the motor grader 10 is already suspended above the ground, such as when the motor grader 10 is traveling down an assembly line, the positioning 304 would include maintaining the motor grader 10 off of the ground.

The positioning 304 may also include connecting the strap 50 to the blocks 44 by advancing the strap 50 through openings 60 in the blocks 44. The strap 50 and connected blocks 44 may then be wrapped around the rim 20 to position the blocks 44 in the annular configuration directly on the rim 20.

With respect to the transport tire 200, the positioning 304 may include advancing hinge members, such as hinge pins 214, through openings 216 of adjacent blocks 210 to connect the blocks 210 together.

The method 300 may further include securing 306 the blocks 44 in the annular configuration on the rim 20. The securing 306 may include tensioning the blocks 44 against the rim 20. For example, the lever 70 of the tensioner 52 may be pivoted in direction 72 to apply tension to the strap 50 and produce radial forces in direction 53 on the blocks 44 which presses the blocks 44 tightly against the rim 20 (see FIG. 2).

### INDUSTRIAL APPLICABILITY

The industrial applicability of the embodiments of a transport tire and method described herein will be readily appreciated from the foregoing discussion. At least one embodiment of the disclosed transport tire may be used to replace a work tire of a machine to reduce the height and/or width of the machine for transport or storage. Examples of such machines include those used for construction, mining, farming, or other similar industries. The machines may be self-propelled vehicles or vehicles intended to be pushed or pulled by another machine. In some embodiments, the machine may be, for example, a motor grader, tractor, dozer, road reclaimer, scraper, or loader.

In general, a transport tire has been disclosed that has a smaller profile on a rim than the corresponding work tire which reduces the height and/or width of the machine. The smaller profile of the transport tire may permit the machine to be transported using a container that could not accommodate the machine when the work tires are installed on the rims. The smaller profile of the transport tire may also permit the machines to be packed more efficiently into transport containers.

In at least one embodiment, the transport tire of the present disclosure includes blocks having a non-annular handling configuration that permits a user to easily handle and wrap the tire around a rim. The transport tire has end portions that are releasably connectable to permit a user or automated process to easily secure the transport tire in an annular configuration on the rim prior to transport. Upon the machine reaching its desired destination, the end portions of the transport tire are disconnected and the transport tire is removed from the rim. The releasable end portions of the transport tire permit the transport tire to be connected to and removed from the rim without removing the rim from the vehicle, in contrast to prior approaches.

In at least one embodiment, the transport tire includes a plurality of releasable connections. The releasable connections permit a single transport tire to be secured to differently sized rims. For example, the releasable connections permit one or more blocks to be disconnected to reduce the length of the transport tire for a smaller diameter rim. Conversely, the releasable connections permit additional blocks to be connected to increase the length of the transport tire for a larger diameter rim.

Those skilled in the art will recognize that a wide variety of modifications, alterations, and combinations can be made with respect to the above described embodiments, and that such modifications, alterations, and combinations, are to be viewed as being within the scope of the disclosure. Methods described herein can be performed in any suitable order unless otherwise indicated herein or otherwise clearly contradicted by context.

What is claimed is:

1. A transport tire comprising:
a plurality of blocks having a non-annular, handling configuration and an annular, installed configuration;
end portions of the transport tire configured to be releasably connected to secure the blocks in the annular, installed configuration; and
at least one connecting member connecting the blocks and permitting the connected blocks to be repositioned from the annular, installed configuration to the non-annular, handling configuration.

2. The transport tire of claim 1 wherein the plurality of blocks and the at least one connecting member form a plurality of releasable connections that permit at least one block to be disconnected from the other blocks to adjust a length of the transport tire.

3. The transport tire of claim 1 wherein each of the blocks includes a projection that cooperates with a recess of an adjacent block.

4. The transport tire of claim 1 wherein the at least one connecting member includes an elongated, flexible member configured to maintain the blocks in the annular, installed configuration.

5. The transport tire of claim 4 wherein the blocks include openings sized to receive the flexible member.

6. The transport tire of claim 1 further comprising a tensioner operably coupled to the end portions for tensioning the blocks in the annular, installed configuration.

7. The transport tire of claim 6 wherein at least one of the blocks includes a recess for receiving the tensioner.

8. The transport tire of claim 1 wherein the blocks are connected together at hinge connections between adjacent blocks and the at least one connecting member includes a plurality of hinge members of the hinge connections.

9. The transport tire of claim 1 wherein the blocks each include an intermediate layer sandwiched between an inner layer and an outer layer, wherein at least two of the intermediate layer, the inner layer, and the outer layer are made of different materials.

10. An apparatus for reducing a height of a machine during transport, the apparatus comprising:
a plurality of track members for being secured around a rim and for being removed therefrom; and
a plurality of releasable connections connecting the track members together, the releasable connections being configured to permit at least one track member to be disconnected from the other track members for a smaller diameter rim and configured to permit at least one track member to be connected to the other track members for a larger diameter rim.

11. The apparatus of claim 10 wherein each of the track members includes a recess configured to receive a projection of an adjacent track member.

12. The apparatus of claim 10 wherein the track members are connected in series.

13. The apparatus of claim 10 further comprising a tensioner operably coupled to the track members and configured to tension the track members.

14. The apparatus of claim 10 wherein the releasable connections include an elongated, flexible member sized to extend through openings of the track members.

15. The apparatus of claim 10 wherein the releasable connections include hinge connections between the track members, the hinge connections including removable hinge pins.

16. A method of assembling a transport tire on a rim of a machine, the method comprising:
selecting a plurality of blocks that corresponds to a size of a rim;
positioning the blocks in an annular configuration directly on the rim; and
securing the blocks in the annular configuration on the rim.

17. The method of claim 16 wherein positioning the blocks in the annular configuration includes rearranging the blocks from a non-annular, handling configuration to the annular configuration.

18. The method of claim 16 wherein securing the blocks in the annular configuration on the rim includes tensioning the blocks against the rim.

19. The method of claim 16 further comprising advancing an elongated, flexible member through openings in the blocks and securing the blocks in the annular configuration on the rim includes tensioning the flexible member.

20. The method of claim 16 further comprising advancing hinge members through openings of adjacent blocks.
